(19) United States
(12) Patent Application Publication
(10) Pub. No.: US 2024/0291090 A1
(43) Pub. Date: Aug. 29, 2024

(54) BATTERY PACK DEVICE FOR VEHICLE

(71) Applicants: Hyundai Motor Company, Seoul (KR); Kia Corporation, Seoul (KR)

(72) Inventors: In Gook Son, Incheon (KR); Yu Ri Oh, Hwaseong (KR); Seok Eun Yoon, Seoul (KR)

(21) Appl. No.: 18/362,258

(22) Filed: Jul. 31, 2023

(30) Foreign Application Priority Data
Feb. 28, 2023 (KR) 10-2023-0027101

(51) Int. Cl. H01M 50/249; H01M 50/242; H01M 50/244; H01M 50/264

(52) U.S. Cl. CPC H01M 50/249; H01M 50/242; H01M 50/244; H01M 50/264; H01M 2220/20

(57) ABSTRACT

A battery pack device for a vehicle having a movable side step includes: a lower casing including a battery side member configured to be coupled to a lateral lower side of a vehicle body of the vehicle, and a downward guide provided in the battery side member and defining a slope to guide the movable side step of the vehicle to move downwards in the event of a collision of the vehicle.

### CROSS REFERENCE TO RELATED APPLICATION

The present application claims under 35 U.S.C. § 119(a) the benefit of Korean Patent Application No. 10-2023-0027101, filed on Feb. 28, 2023, the entire contents of which are incorporated by reference herein.

### BACKGROUND

### (a) Technical Field

The present disclosure relates to a battery pack device for a vehicle having a movable side step, more particularly, to the battery pack device mounted to the vehicle such that in the event of a collision of the vehicle, a guide of the battery pack device guides the movable side step to move downwards to prevent damage to a battery pack of the battery pack device.

### (b) Description of the Related Art

An electric vehicle and/or other types of environmentally-friendly vehicles typically include a battery pack mounted to supply electric power to a driving motor.

The battery pack may include a plurality of battery modules, and a battery casing surrounding the battery modules, and each battery module typically includes a plurality of battery cells.

The battery casing typically includes a lower casing to surround a lower side and lateral sides of the battery module, and an upper cover to cover an upper side of the lower casing so that the battery module can be accommodated in an inner space formed between the upper cover and the lower casing.

On a lateral side of the lower casing, a battery side member may be placed to provide a mounting portion for coupling with a vehicle body and to provide a shock absorbing function against a collision of a vehicle.

In some vehicles, such as a luxury vehicle, a movable side step protrudes from a side of a vehicle body and assists a passenger in getting in and out more easily when the passenger gets in and out of the vehicle. However, when a collision of the vehicle occurs, an actuation link and the like provided for actuating the side step may hit the battery pack.

Matters described as the related art are provided merely for promoting understanding for the background of the disclosure, and should not be taken as the prior art already known to a person having ordinary knowledge in the art.

### SUMMARY

The disclosure provides a battery pack device of a vehicle including a movable side step, in which parts for actuating the side step are prevented from hitting a battery pack mounted to a lower side of a vehicle body even when a collision (e.g., a broadside collision) of the vehicle occurs, so that damage to an internal battery module can be minimized, thereby further improving the safety of the battery pack.

According to an embodiment of the disclosure, a battery pack device includes: a lower casing including a battery side member configured to be coupled to a lateral lower side of a vehicle body, and a downward guide provided in the battery side member and defining a slope to guide a movable side step to move downwards in the event of a collision of a vehicle.

The downward guide may be provided to guide an actuation link of the movable side step to move downwards.

The battery side member may include a guide mounting groove formed in a portion of the battery side member adjacent to the actuation link, and the downward guide may be provided in the guide mounting groove.

The downward guide may include: a vertical portion coupled to the battery side member inside the guide mounting groove, a horizontal portion connected to an upper side of the vertical portion in a horizontal direction, and an inclined portion connecting an outer end portion of the horizontal portion facing towards an outside of the vehicle body and a lower end of the vertical portion, and defining the slope.

The battery pack device may further include: a battery side longitudinal member provided inside the battery side member of the lower casing, and a module anti-crushing member provided in an upper side of the battery side longitudinal member, and preventing a battery module accommodated in the lower casing from being crushed in a vertical direction due to movement of the movable side step when a collision of a vehicle occurs.

The module anti-crushing member may be provided to prevent the battery module from being crushed in the vertical direction due to the movement of an actuation link of the movable side step.

The module anti-crushing member may be locally provided in a portion adjacent to the actuation link of the movable side step.

The module anti-crushing member may be placed so that a top of the module anti-crushing member is at least higher than a top of the battery module.

The module anti-crushing member may include: a load supporter coupled to an upper side of the battery side longitudinal member and forming the top higher than the top of the battery module, and a coupling panel extended downwards from the load supporter and coupled being in contact with a lateral side of the battery side longitudinal member to increase coupling rigidity.

The load supporter of the module anti-crushing member may be formed along a longitudinal direction of the battery side longitudinal member while having a cross-section in which a plurality of closed loops are partitioned up and down by at least one partition wall. A vehicle includes the above-described battery pack device.

According to an embodiment of the disclosure, a battery pack device includes: a lower casing accommodating a battery module, a battery side member provided in a lower casing at a side of a vehicle body, a battery side longitudinal member provided inside the lower casing and spaced part inwards from the battery side member, a downward guide provided in the battery side member and defining a slope to guide a movable side step to move downwards when a collision of a vehicle occurs, and a module anti-crushing member provided in the battery side longitudinal member to prevent the battery module from being vertically crushed due to movement of the movable side step when the collision of the vehicle occurs.

The downward guide may be provided to guide an actuation link of the movable side step to move downwards.

The battery side member may include a guide mounting groove formed in a portion of the battery side member adjacent to the actuation link and recessed from the side of the vehicle body towards an inside of the vehicle body, and the downward guide may be provided in the guide mounting groove.

The downward guide may include: a vertical portion coupled to the battery side member inside the guide mounting groove, a horizontal portion connected to an upper side of the vertical portion in a horizontal direction, and an inclined portion connecting an outer end portion of the horizontal portion facing towards an outside of the vehicle body, and defining a slope, and the vertical portion, the horizontal portion, and the inclined portion may be formed to have an inverted triangular cross-section.

The module anti-crushing member may be provided to prevent the battery module from being crushed in a vertical direction due to the movement of the actuation link of the movable side step.

The module anti-crushing member may be locally provided in a portion adjacent to the actuation link of the movable side step.

The module anti-crushing member may be placed so that a top of the module anti-crushing member is at least higher than a top of the battery module.

The module anti-crushing member may include a load supporter coupled to an upper side of the battery side longitudinal member and forming the top higher than the top of the battery module, and a coupling panel extended downwards from the load supporter and coupled being in contact with a lateral side of the battery side longitudinal member to increase coupling rigidity.

The load supporter of the module anti-crushing member may be formed long along a longitudinal direction of the battery side longitudinal member while having a cross-section in which a plurality of closed loops are partitioned up and down by at least one partition wall.

According to the disclosure, in a vehicle including a movable side step, parts for actuating the side step are prevented from hitting a battery pack mounted to a lower side of a vehicle body even when a collision of the vehicle occurs, so that damage to an internal battery module can be minimized, thereby further improving the safety of the battery pack.

### BRIEF DESCRIPTION OF THE DRAWINGS

FIG. 1 is a bottom view of a vehicle with a battery pack according to the disclosure,

FIG. 2 is a cross-sectional view taken along line II-II of FIG. 1,

FIG. 3 is a disassembled view of a battery pack of FIG. 2,

FIG. 4 is a view in which a downward guide and a module anti-crushing member of FIG. 3 are separated individually,

FIG. 5 is a cross-sectional view taken along line V-V of FIG. 3,

FIG. 6 is a cross-sectional view taken along line VI-VI of FIG. 3,

FIG. 7 is a view of a battery side longitudinal member and the module anti-crushing member viewed from inside the battery pack of FIG. 3, and

FIG. 8 is a cross-sectional view of the module anti-crushing member of FIG. 7.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships. aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a.” “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the disclosure will be described in detail with reference to the accompanying drawings, in which the same or similar elements are denoted by the same reference numerals even though they are depicted in different drawings and redundant descriptions thereof will be avoided.

In terms of describing the embodiments of the disclosure, detailed descriptions of related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents and substitutions within the scope and sprit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

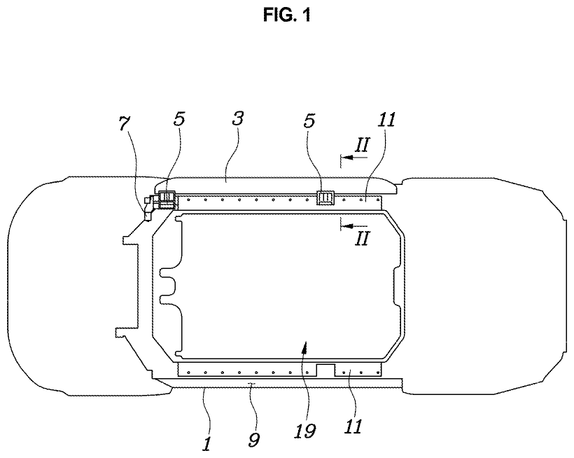

FIG. 1 is a bottom view of a vehicle with a battery pack according to the disclosure, in which a movable side step 3 is provided at a side of a vehicle body 1.

The side step 3 is supported in the vehicle body 1 by a plurality of actuation links 5, and an actuation motor 7 is connected to one of the actuation links 5 so that the side step 3 can be extended from or retracted into the side of the vehicle body 1 by the actuation motor 7 through the actuation link 5.

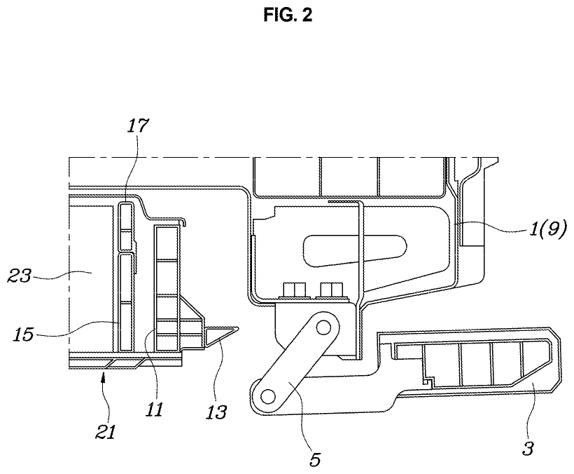

FIG. 2 is a cross-sectional view taken along line II-II of FIG. 1, in which the actuation link 5 is mounted to a lower side of a side sill 9 of the vehicle body 1, a battery side member 11 and a downward guide 13 are provided at an inward side of the vehicle body 1 corresponding to the actuation link 5, a battery side longitudinal member 15 is disposed at an inward side of the battery side member 11, and a module anti-crushing member 17 is provided on the top of the battery side longitudinal member 15.

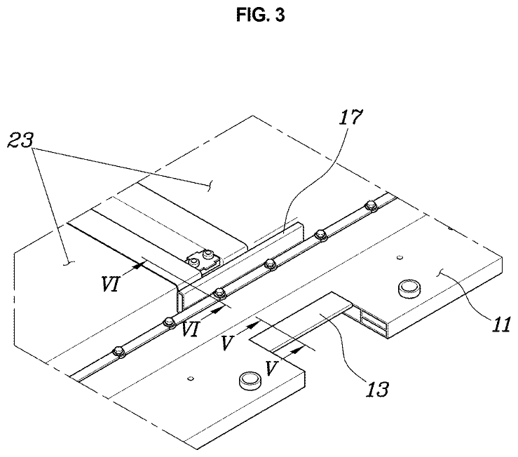

FIG. 3 is a disassembled view of a battery pack 19 of FIG. 2, in which an upper cover of a battery casing is removed, and a battery module 23 is accommodated inside a lower casing 21 of the battery casing.

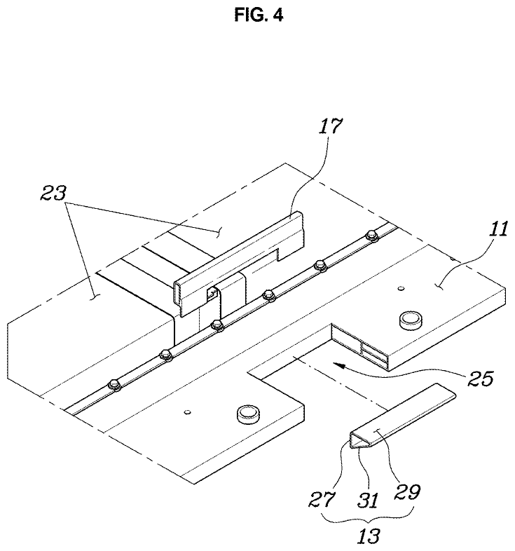

FIG. 4 is a view in which the downward guide 13 and a module anti-crushing member 17 of FIG. 3 are separated individually.

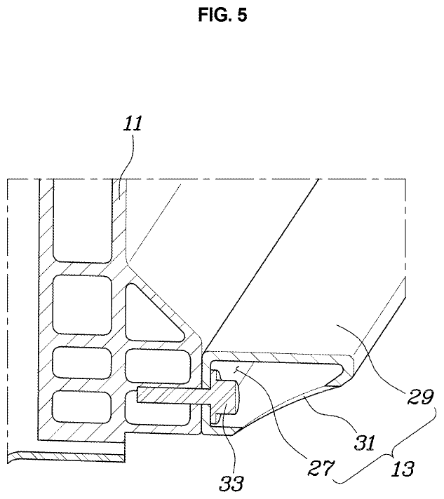

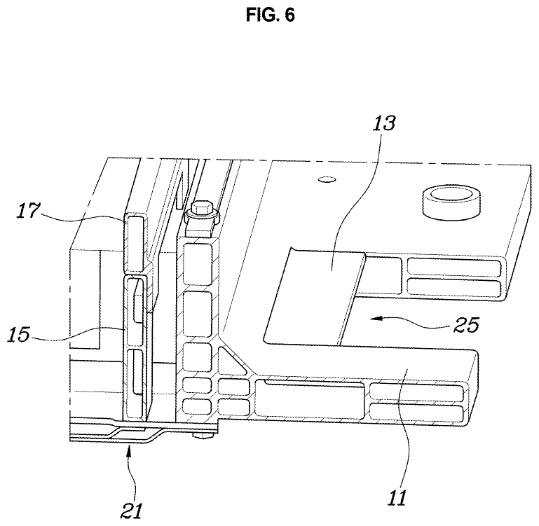

FIG. 5 is a cross-sectional view taken along line V-V of FIG. 3, and FIG. 6 is a cross-sectional view taken along line VI-VI of FIG. 3.

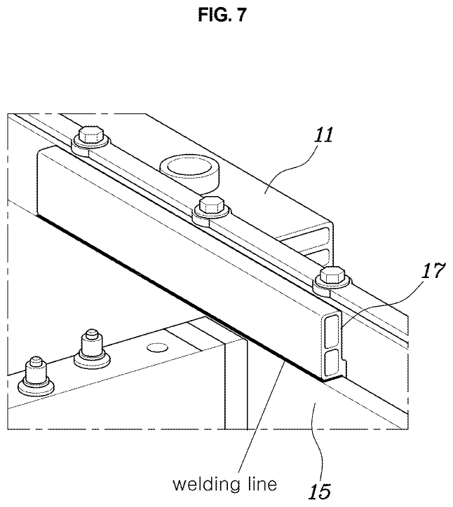

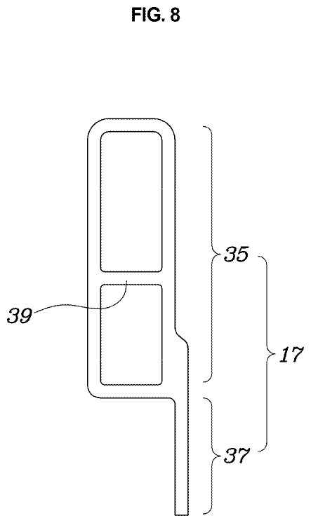

FIG. 7 is a view of the battery side longitudinal member 15 and the module anti-crushing member 17 viewed from inside the battery pack 19 of FIG. 3, and FIG. 8 is a cross-sectional view of the module anti-crushing member 17 of FIG. 7.

Referring to FIGS. 1 to 8, the battery pack 19 of the vehicle according to an embodiment of the disclosure is structured to include the lower casing 21 provided with the battery side member 11 configured to be coupled to a lateral lower side of the vehicle body 1, and the downward guide 13 provided in the battery side member 11 and having a slope to guide the movable side step 3 to move downwards when a collision of the vehicle occurs.

The downward guide 13 is provided to guide the actuation link 5 of the movable side step 3 to move downwards.

In other words, according to an embodiment, when the actuation link 5 used to actuate the movable side step 3 is crushed into the inside of the vehicle body 1 due to the collision of the vehicle, the downward guide 13 guides the actuation link 5 to move downwards, thereby preventing the actuation link 5 from applying a substantial impact to the battery module 23 inside the battery pack 19.

The battery side member 11 is formed with a guide mounting groove 25 formed in a portion of the battery side member 11 adjacent to the actuation link 5, and the downward guide 13 is provided in the guide mounting groove 25.

The downward guide 13 includes a vertical portion 27 coupled to the battery side member 11 inside the guide mounting groove 25, a horizontal portion 29 connected to an upper side of the vertical portion 27 in a horizontal direction, and an inclined portion 31 defining a slope by connecting an outer end portion of the horizontal portion 29 facing towards the outside of the vehicle body 1 and a lower end of the vertical portion 27.

The downward guide 13 may be mounted by welding the vertical portion 27 to the guide mounting groove 25 of the battery side member 11. Alternatively, the vertical portion 27 may be bolted to the guide mounting groove 25 of the battery side member 11 with a fastening bolt 33 as shown in FIG. 5.

Therefore, when the collision of the vehicle body 1 or the like accident causes the actuation link 5 to be pushed and moved toward the battery pack 19, the actuation link 5 is guided to move below the battery pack 19 along the slope formed in the inclined portion 31 of the downward guide 13 and does not directly apply an impact to the battery module 23 inside the battery pack 19, thereby securing the safety of the battery pack 19 against the collision of the vehicle.

Meanwhile, the battery side longitudinal member 15 is provided inside the battery side member 11 of the lower casing 21, and the module anti-crushing member 17 is provided on the top of the battery side longitudinal member 15 and prevents the movable side step 3 from moving and vertically crushing the battery module 23 accommodated in the lower casing 21 when the collision of the vehicle occurs.

According to an embodiment, the module anti-crushing member 17 is provided to prevent the battery module 23 from being crushed in a vertical direction due to the movement of the actuation link 5 of the movable side step 3.

In other words, the collision of the vehicle or the like accident may cause the actuation link 5 to be pushed and rotated toward the inside of the vehicle body 1, thereby compressing the bottom of the battery pack 19. Under this condition, when the bottom of the battery pack 19 is compressed upward by the actuation link 5 and the like parts as described above, the top of the battery pack 19 is relatively less deformed due to the vehicle body 1 placed thereon, and, as a result, the battery module 23 accommodated in the battery pack 19 is likely to be damaged by vertical compressive force. To protect the battery module 23 against the foregoing vertical compressive force, the module anti-crushing member 17 is provided.

To this end, the module anti-crushing member 17 may be locally provided in a portion adjacent to the actuation link 5 of the movable side step 3, and the module anti-crushing member 17 is required to be placed so that the top of the module anti-crushing member 17 is at least higher than the top of the battery module 23.

The module anti-crushing member 17 may include a load supporter 35 coupled to an upper side of the battery side longitudinal member 15 and forming the top higher than the top of the battery module 23, and a coupling panel 37 extended downwards from the load supporter 35 and coupled being in contact with a lateral side of the battery side longitudinal member 15 to increase coupling rigidity.

Thus, the module anti-crushing member 17 may be coupled to the upper side of the battery side longitudinal member 15 by welding or the like, and the coupling panel 37 may also be coupled to the battery side longitudinal member 15 by welding or the like, so that the module anti-crushing member 17 can be solidly supported without being easily buckled by the foregoing compressive force vertically acting on the battery pack 19, thereby effectively preventing the battery module 23 from being crushed.

The load supporter 35 of the module anti-crushing member 17 may be formed along the longitudinal direction of the battery side longitudinal member 15 while having a cross-section in which a plurality of closed loops are formed by at least one partition wall 39.

Therefore, the load supporter 35 of the module anti-crushing member 17 becomes more rigid, thereby more stably withstanding the compressive force acting on the battery pack 19 in the vertical direction.

In other words, a battery pack 19 of a vehicle according to an embodiment of the disclosure may be structured to include a lower casing 21 accommodating a battery module 23, a battery side member 11 provided in a lower casing 21 at a side of the vehicle body 1, a battery side longitudinal member 15 provided inside the lower casing 21 and spaced part inwards from the battery side member 11, a downward guide 13 provided in the battery side member 11 and defining a slope to guide a movable side step to move downwards when a collision of the vehicle occurs, and a module anti-crushing member 17 provided in the battery side longitudinal member 15 to prevent the battery module 23 from being vertically crushed due to movement of the movable side step 3 when the collision of the vehicle occurs.

The downward guide 13 may be provided to guide the actuation link 5 of the movable side step 3 to move downwards.

The battery side member 11 may include a guide mounting groove 25 formed in a portion of the battery side member 11 adjacent to the actuation link 5 and recessed from the side of the vehicle body 1 towards the inside of the vehicle body 1, and the downward guide 13 may be provided in the guide mounting groove 25.

The downward guide 13 may include a vertical portion 27 coupled to the battery side member 11 inside the guide mounting groove 2, a horizontal portion 29 connected to an upper side of the vertical portion 27 in a horizontal direction, and an inclined portion 31 forming a slope by connecting an outer end portion of the horizontal portion 29 facing towards the outside of the vehicle body 1, in which the vertical portion 27, the horizontal portion 29, and the inclined portion 31 may be formed to have an inverted triangular cross-section.

The module anti-crushing member 17 may be provided to prevent the battery module 23 from being crushed in a vertical direction due to the movement of the actuation link 5 of the movable side step 3.

The module anti-crushing member 17 may be locally provided in a portion adjacent to the actuation link 5 of the movable side step 3.

The module anti-crushing member 17 is required to be placed so that the top of the module anti-crushing member 17 is at least higher than the top of the battery module 23.

The module anti-crushing member 17 includes a load supporter 35 coupled to an upper side of the battery side longitudinal member 15 and forming the top higher than the top of the battery module 23, and a coupling panel 37 extended downwards from the load supporter 35 and coupled being in contact with a lateral side of the battery side longitudinal member 15 to increase coupling rigidity.

The load supporter 35 of the module anti-crushing member 17 may be formed along the longitudinal direction of the battery side longitudinal member 15 while having a cross-section in which a plurality of closed loops are partitioned up and down by at least one partition wall 39.

Although specific embodiments of the disclosure have been illustrated and described as above, various modifications and changes can be made by a person having ordinary knowledge in the art without departing from the scope of technical ideas defined by the appended claims.

What is claimed is:

1. A battery pack device for a vehicle having a movable side step, the battery pack device comprising:
a lower casing comprising a battery side member configured to be coupled to a lateral lower side of a vehicle body of the vehicle; and
a downward guide provided in the battery side member, the downward guide defining a slope to guide the movable side step to move downwards upon occurrence of a collision of the vehicle.

2. The battery pack device of claim 1, wherein the downward guide is configured to guide an actuation link of the movable side step to move downwards.

3. The battery pack device of claim 2, wherein:
the battery side member comprises a guide mounting groove formed in a portion of the battery side member adjacent to the actuation link; and
the downward guide is provided in the guide mounting groove.

4. The battery pack device of claim 3, wherein the downward guide comprises:
a vertical portion coupled to the battery side member inside the guide mounting groove:
a horizontal portion connected to an upper side of the vertical portion in a horizontal direction; and
an inclined portion connecting an outer end portion of the horizontal portion facing towards an outside of the vehicle body and a lower end of the vertical portion, and forming the slope.

5. The battery pack device of claim 1, further comprising:
a battery side longitudinal member provided inside the battery side member of the lower casing; and
a module anti-crushing member provided in an upper side of the battery side longitudinal member, and preventing a battery module accommodated in the lower casing from being crushed in a vertical direction due to the movement of the movable side step upon a collision of the vehicle.

6. The battery pack device of claim 5, wherein the module anti-crushing member is provided to prevent the battery module from being crushed in the vertical direction due to movement of an actuation link of the movable side step.

7. The battery pack device of claim 6, wherein the module anti-crushing member is locally provided in a portion adjacent to the actuation link of the movable side step.

8. The battery pack device of claim 6, wherein the module anti-crushing member is placed so that a top of the module anti-crushing member is at least higher than a top of the battery module.

9. The battery pack device of claim 6, wherein the module anti-crushing member comprises:
a load supporter coupled to an upper side of the battery side longitudinal member and forming the top higher than the top of the battery module; and
a coupling panel extended downwards from the load supporter and coupled being in contact with a lateral side of the battery side longitudinal member to increase coupling rigidity.

10. The battery pack device of claim 9, wherein the load supporter of the module anti-crushing member is formed long along a longitudinal direction of the battery side longitudinal member while having a cross-section in which a plurality of closed loops are partitioned up and down by at least one partition wall.

11. A vehicle comprising the battery pack device of claim 1.

12. A battery pack device for a vehicle having a movable side step, the battery pack device comprising:
a lower casing accommodating a battery module:
a battery side member provided in a lower casing at a side of a vehicle body of the vehicle:
a battery side longitudinal member provided inside the lower casing and spaced part inwards from the battery side member;
a downward guide provided in the battery side member and defining a slope to guide the movable side step to move downwards upon occurrence of a collision of the vehicle; and
a module anti-crushing member provided in the battery side longitudinal member to prevent the battery module from being vertically crushed due to movement of the movable side step upon occurrence of the collision of the vehicle.

13. The battery pack device of claim 12, wherein the downward guide is provided to guide an actuation link of the movable side step to move downwards.

14. The battery pack device of claim 13, wherein:
the battery side member includes a guide mounting groove formed in a portion of the battery side member adjacent to the actuation link and recessed from the side of the vehicle body towards an inside of the vehicle body, and
the downward guide is provided in the guide mounting groove.

15. The battery pack device of claim 14, wherein the downward guide comprises:
a vertical portion coupled to the battery side member inside the guide mounting groove:
a horizontal portion connected to an upper side of the vertical portion in a horizontal direction; and
an inclined portion connecting an outer end portion of the horizontal portion facing towards an outside of the vehicle body, and forming a slope, and
the vertical portion, the horizontal portion, and the inclined portion are formed to have an inverted triangular cross-section.

16. The battery pack device of claim 13, wherein the module anti-crushing member is provided to prevent the battery module from being crushed in a vertical direction due to movement of the actuation link of the movable side step.

17. The battery pack device of claim 16, wherein the module anti-crushing member is locally provided in a portion adjacent to the actuation link of the movable side step.

18. The battery pack device of claim 17, wherein the module anti-crushing member is placed so that a top of the module anti-crushing member is at least higher than a top of the battery module.

19. The battery pack device of claim 18, wherein the module anti-crushing member comprises:
a load supporter coupled to an upper side of the battery side longitudinal member and forming the top higher than the top of the battery module; and
a coupling panel extended downwards from the load supporter and coupled being in contact with a lateral side of the battery side longitudinal member to increase coupling rigidity.

20. The battery pack device of claim 19, wherein the load supporter of the module anti-crushing member is formed long along a longitudinal direction of the battery side longitudinal member while having a cross-section in which a plurality of closed loops are partitioned up and down by at least one partition wall.
